(19) United States
(12) Patent Application Publication
(10) Pub. No.: US 2004/0117100 A1
(43) Pub. Date: Jun. 17, 2004

(54) Hydroplaning detection apparatus

(75) Inventor: Keiyu Kin, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 10/719,406

(22) Filed: Nov. 21, 2003

(30) Foreign Application Priority Data
Dec. 17, 2002 (JP) 2002-365687

(51) Int. Cl. G06F 7/70

(52) U.S. Cl. 701/70; 701/74

(57) ABSTRACT

Hydroplaning detection apparatus operates to feature extract a change pattern of vibration detection values for the respective front and rear wheel sides of a vehicle by excluding inherent tire influences on the vibration detection values, to execute pattern matching between the front and rear wheel sides on the basis of the feature extracted change patterns of the detection values, to obtain a time difference from a coincidence of the change patterns, and to calculate a first vehicle speed based on the time difference and a reference distance such as a wheel base of the vehicle. The hydroplaning detection apparatus also operates to calculate a second vehicle speed based on an average value of wheel speeds detected by the rear wheel speed sensor. The hydroplaning detection apparatus determines that hydroplaning has occurred if a deviation between the first vehicle speed and the second vehicle speed is greater than a certain value.

### BACKGROUND OF THE INVENTION

The present invention relates to a hydroplaning detection apparatus for detecting hydroplaning that happens when a vehicle runs on a wet road surface covered by a water film.

Hydroplaning is a phenomenon in which a wedge of water is created between the road surface and tires during a high speed driving on a wet road surface so that vehicle tires are lifted and lose their contact with the road surface (see FIG. 9) Also, hydroplaning is a phenomenon in which tires are very slippery with their contact with a road surface lost by a hydrodynamic pressure of water that is created when tires can not remove water during a high speed driving on a wet road surface. This is schematically shown in FIG. 9(b). Water film penetrates as a wedge between the tire and the road surface so as to create a force Fu in a direction to lift the tire and a force Dr in a direction to decrease the rotation speed VF of the tire. Because hydroplaning is a serious problem for a safety drive on a high way or express way, various techniques haven been attempted to detect hydroplaning.

For example, a proposal has been made to detect hydroplaning based on a decreasing degree (decreasing pattern) of wheel speed of the front wheels due to the resistance of water film. Japanese Patent No.3052013 (columns [0007], [0015], FIGS. 4 and 7, etc.) and Japanese Patent No. 3123683 (column [0011], FIGS. 4 and 5, etc.) by the applicant and the inventor of the present invention also propose to detect hydroplaning based on a change pattern of wheel speed of the front wheels. To be more specific, as shown in FIG. 10, a hydroplaning detection apparatus previously stores a plurality of typical change patterns for the front wheel speed (change patterns of time-wheel speed curve). The hydroplaning detection apparatus executes a pattern matching between these change patterns and a change pattern of the front wheel speed that is actually measured and extracted, and determines that hydroplaning has occurred, if this actual change pattern coincides at a certain similarity with the previously stored change pattern indicating hydroplaning. When the vehicle passes over a bump or a level difference on a road, a pair of plus and minus waves generates. However, in the case of hydroplaning, only minus waves generate. Another proposal has been made to detect hydroplaning, in which vibration at the unsprung side is detected as an influence on the suspensions exerted by the resistance of water film during driving, and hydroplaning can be detected based on the natural frequency of the suspensions.

Japanese Patent No. 3232520 (columns [0003], [0005], FIG. 1, etc.) by the applicant and the inventor of the present invention proposes to detect partial hydroplaning. It is more difficult to detect partial hydroplaning in which part of the tire still contacts with the road surface than to detect complete hydroplaning in which tires completely ride on a water film on the road surface. This hydroplaning detection apparatus detects hydroplaning based on a finding that once partial hydroplaning occurs, intrinsic frequency components contained in an output signal of the wheel speed sensors and corresponding to the wheel rotation speed shift toward a low-frequency side by receiving a viscous resistance of the water film. The hydroplaning detection apparatus processes signals from a band-pass filter provided for each vehicle speed band, and detects partial hydroplaning.

However, in the above techniques using the pattern matching, it is difficult to detect hydroplaning if the water film thickness is less than a certain thickness (e.g., 10 mm). In other words, detection of hydroplaning is difficult if the hydroplaning occurs in a condition where the water film thickness is not sufficiently thick. It is also difficult to detect hydroplaning (partial hydroplaning) at an early stage. If hydroplaning occurs with the water film thickness being more than 10 mm, even the driver can recognize a slowdown or deceleration feel and thus the provision of such a system is not advantageous. In other words, it is difficult to detect hydroplaning and alarm the driver of its occurrence before the driver recognizes the hydroplaning. Despite the theory, deceleration degree or change pattern of the wheel speed at the time of hydroplaning is actually similar to the case when the vehicle runs on a rough road, level difference, icy road, etc. Therefore, it is desired to detect hydroplaning in a more accurate manner.

The other technique for partial hydroplaning can detect an occurrence of hydroplaning even if the water film thickness is less than 10 mm. However, in terms of more accurately detecting an occurrence of hydroplaning, it is desired that a further improvement is made by detecting a slight shift amount of resonance frequency in accordance with road conditions such as roughness and a level difference.

Accordingly, the present invention mainly seeks to provide a hydroplaning detection apparatus which can detect hydroplaning due to a less thick water film or which can detect hydroplaning occurred at an early stage, without confusing with a road bump or level difference (hereinafter referred to as a “road bump, etc.”).

### SUMMARY OF THE INVENTION

After extensive research and development, unlike the conventional detection of hydroplaning merely focused on the behavior of front wheels, the inventor proposes to determine hydroplaning by additionally taking into consideration the behavior of rear wheels.

According to the present invention, a hydroplaning detection apparatus for a vehicle includes wheel speed sensors for detecting vibrations from a road surface through tires, an input section through which the wheel speed sensors input their detection values; and a processing unit for processing the detection values to determine hydroplaning. The wheel speed sensors are provided at front and rear wheel sides, respectively. The processing unit operates to feature extract a change pattern of the detection values for the respective front and rear wheel sides by excluding inherent tire influences on the detection values, to execute pattern matching between the front and rear wheel sides on the basis of the feature extracted change patterns of the detection values, to obtain a time difference from a coincidence of the change patterns, and to calculate a first vehicle speed based on the time difference and a reference distance that is previously stored in the hydroplaning detection apparatus. The processing unit also operates to calculate a second vehicle speed based on an average value of wheel speeds detected by the wheel speed sensor that is provided at the rear wheel side. The hydroplaning detection apparatus determines that hydroplaning has occurred if a deviation between the first vehicle speed and the second vehicle speed is greater than a certain value.

With this construction of the hydroplaning detection apparatus, the first vehicle speed is subject to hydroplaning but is not subject to a road bump, etc. Meanwhile, the second vehicle speed is not subject to hydroplaning and a road bump, etc. The hydroplaning detection apparatus according to the present invention determines an occurrence of hydroplaning by utilizing these two vehicle speeds with different characteristics.

In the aforementioned hydroplaning detection apparatus, the processing unit may determine that hydroplaning has occurred if the deviation exceeds the certain value for a certain period of time.

With this construction of the hydroplaning detection apparatus, it is possible to decrease detection errors.

Other features and advantages of the present invention will be apparent from the following description taken in connection with the accompanying drawings.

### BRIEF DESCRIPTION OF THE DRAWINGS

Preferred embodiments of the present invention will be described below, by way of example only, with reference to the accompanying drawings, in which:

FIG. 1 is a system diagram of a vehicle equipped with a hydroplaning detection apparatus according to the present invention;

FIG. 2 is a block diagram illustrating the hydroplaning detection apparatus;

FIG. 3 is a block diagram illustrating a first vehicle speed measuring unit which forms a main part of the hydroplaning detection apparatus;

FIG. 4 explains variations of detection values detected by wheel speed sensors;

FIG. 5 is a flow chart showing the manner of operation of the hydroplaning detection apparatus;

FIG. 6 schematically explains the manner of measuring a first vehicle speed, wherein (a) illustrates an instance where the vehicle runs on a road including points a and b toward the point b, (b) illustrates in time sequence a changes in detection values of the respective front and rear wheel speeds in the instance of (a), and (c) illustrates in time sequence changes in the detection values after being processed by digital filters;

FIG. 7 is a flow chart showing operations for measuring the first vehicle speed;

FIG. 8 schematically shows array variables, wherein (a) shows array variables Vf(n) to which a normalization process has been applied, and (b) shows array variables Vf(m) to which the normalization process has been applied;

FIG. 9 illustrates an example of prior art; and

FIG. 10 illustrates an example of prior art.

### INCORPORATION BY REFERENCE

The following references are hereby incorporated by reference into the detailed description of the invention, and also as disclosing alternative embodiments of elements or features of the preferred embodiment not otherwise set forth in detail above or below or in the drawings. A single one or a combination of two or more of these references may be consulted to obtain a variation of the preferred embodiment.

Japanese Patent Application No.2002-365687 filed on Dec. 17, 2002.

Japanese Patent No.3052013 filed on Oct. 16, 1991.

Japanese Patent No.3123683 filed on Oct. 30, 1992.

Japanese Patent No. 3232520 filed on Sep. 29, 1993.

### DETAILED DESCRIPTION OF THE INVENTION

With reference to the accompanying drawings, a preferred embodiment of a hydroplaning detection apparatus according to the present invention will be described.

PRINCIPLE OF HYDROPLANING DETECTION

The principle for detecting hydroplaning according to this preferred embodiment will be described. If the front wheels and the rear wheels pass over a water film on the road surface along the exactly or almost same ruts, because the front wheels remove water, there is a difference between front wheels and rear wheels in resistance received from the water film on the road surface. The front wheels directly receive the resistance of the water film and a variation occurs in the wheel speed, so that the period (frequency) becomes unstable due to the water film. On the contrary, because the rear wheels pass the same ruts just after the front wheels remove water, the rear wheels receive little resistance from the water film. Therefore, unlike th-e front wheels, no change in the wheel speed occurs due to the water film, leading to stable frequency. In other words, wheel speed of the front wheels is subject to hydroplaning, and wheel speed of the rear wheels is not subject to hydroplaning.

In this preferred embodiment, as the first vehicle speed that is subject to hydroplaning, a vehicle speed is calculated by matching a change pattern of the front wheel speed and a change pattern of the rear wheel speed. Further, as a reference vehicle speed or the second vehicle speed that is not subject to hydroplaning, a vehicle speed is obtained by calculating the moving average of the rear wheel speed. The first vehicle speed and the second vehicle speed are then compared to obtain a difference, and if the difference is more than a certain value (threshold value), the hydroplaning detection apparatus determines that hydroplaning has occurred. To be described later, the first vehicle speed and the second vehicle speed are not subject to a road bump, etc.

Such a method enables the detection of hydroplaning to be made in a reliable manner, unlike the method for detecting hydroplaning only based on the behavior of front wheels or the method for detecting hydroplaning simply based on a difference between the front wheel speed and the rear wheel speed. The preferred embodiment of the present invention will be described below.

Construction of Hydroplaning Detection Apparatus

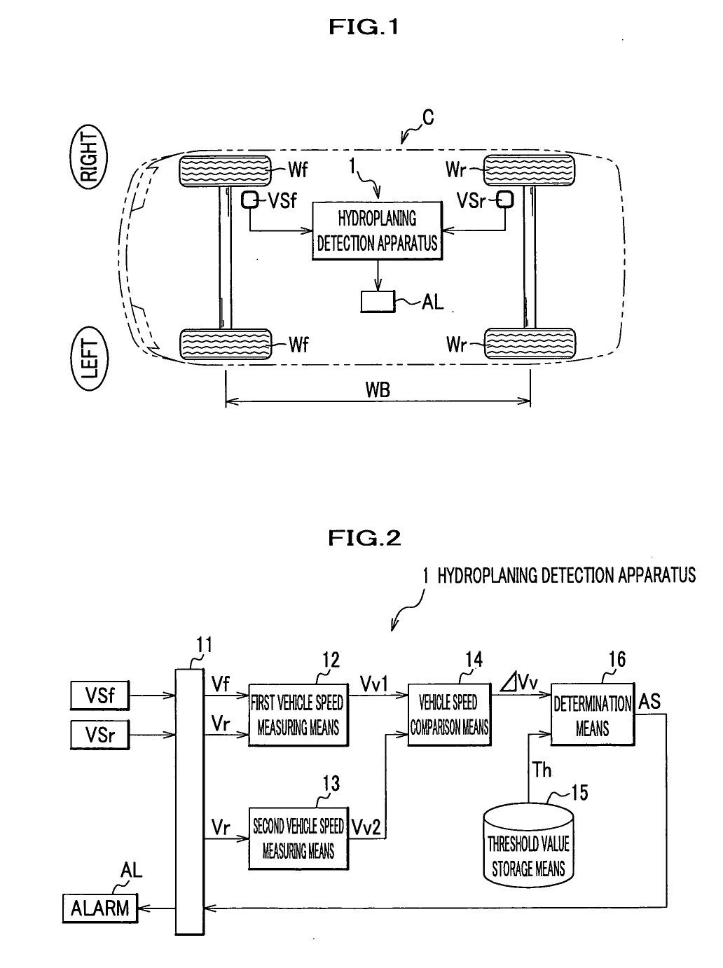

System of a vehicle C equipped with a hydroplaning detection apparatus will be described with reference to FIG. 1. As shown in FIG. 1, the vehicle C which mounts the hydroplaning detection apparatus 1 according to this preferred embodiment is a four wheeled vehicle including two front wheels Wf and two rear wheels Wr. The vehicle C is provided with a wheel speed sensor VS (VSf, VSr) at a front right wheel Wf and a rear right wheel Wr, respectively. The vehicle C is also provided with an alarm AL which informs the driver of an occurrence of hydroplaning. Subscripts f and r represent “front wheel side” and “rear wheel side”, respectively.

The wheel speed sensor VS (VSf, VSr) is a generally known sensor which generates vehicle speed pulses, for example, by the use of a Hall element. In the vehicle speed pulse (analog electric signal) that is generated by the wheel speed sensor VSf, VSr and transmitted to the hydroplaning detection apparatus 1, the number of pulses per a unit of time increases as the vehicle speed increases, and the number of pulses per a unit of time decreases as the vehicle speed decreases. Vehicles equipped with an antilock braking system or a traction control system usually include wheel speed sensors VS, and these sensors can be used for the detection of hydroplaning.

The hydroplaning detection apparatus 1 includes a micro computer (not shown) and its peripheral circuits, so that the micro computer reads out a program written in a non-illustrated ROM and executes respective modules of the program (e.g., first and second vehicle speed measuring means 12, 13, vehicle speed comparison means 14, etc.) to determine hydroplaning. Further, in order to detect (determine) hydroplaning, the hydroplaning detection apparatus includes an input/output port (input/output interface 11 to be described later) for inputting/outputting various signals, information, commands, etc., and a non-illustrated A/D converter for converting an analog signal to a digital signal so as to allow the micro computer to execute digital processing.

With reference to FIGS. 2 through 4, the hydroplaning detection apparatus 1 will be described in detail.

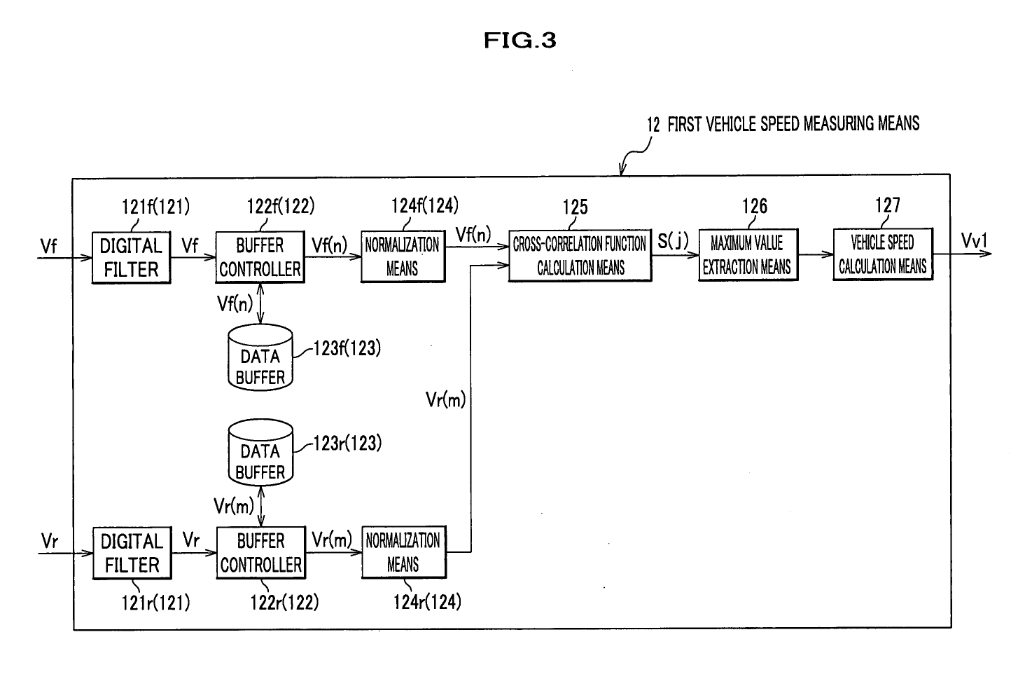

As shown in FIG. 2, the hydroplaning detection apparatus 1 mainly consists of an input/output interface 11, a first vehicle speed measuring means 12, a second vehicle speed measuring means 13, a vehicle speed comparison means 14, a threshold value storage means 15, and a determination means 16. Further, as shown in FIG. 3, the first vehicle speed measuring means 12 consists of digital filters 121 (121f, 121r), buffer controllers 122 (122f, 122r) data buffers 123 (123f, 123r), normalization means 124 (124f, 124r) across-correlation function calculation means 125, a maximum value extraction means 126, and vehicle speed calculation means 127. The input/out interface 11 corresponds to the input section, and the first vehicle speed measuring means 12 through the determination means 16 correspond to the processing unit.

Input/Output Interface

The input/output interface 11 functions to input data to be treated by the hydroplaning detection apparatus 1 and to output data that have been processed by the hydroplaning detection apparatus 1 (output of an alarm signal AS). In the hydroplaning detection apparatus 1, wheel speed (detection values V (Vf, Vr)) represented by a digital data is treated as a vehicle speed pulse. In this preferred embodiment, sampling rate for wheel speed is 1000 Hz.

First Vehicle Speed Measuring Means

The first vehicle speed measuring means 12 receives digital data as detection values V (Vf, Vr) of the wheel speeds from the input/output interface 11 at every 10 millisecond, and functions to measure the first vehicle speed Vv1 that is subject to hydroplaning. Principle of measuring the first vehicle speed Vv1 will now be described.

Detection values Vf, Vr from the wheel speed sensors VSf, VSr vary because of a road bump, etc. (roughness or level difference on the road surface). Such a change first appears in the detection values Vf at the front wheel sensor VSf and then appears in the detection values Vr at the rear wheel sensor VSr, if the vehicle runs in the advance direction. In this instance, if the time interval between the changes of the detection values Vf, Vr derived from the same level difference, i.e., time lag for the phase difference between change patterns of the front and rear wheel speed Svf, Vr, can be obtained, it is possible to calculates vehicle speed (first vehicle speed Vv1) from the wheel base (reference distance) WB of the vehicle C.

Because the fist vehicle speed Vv1 is obtained by additionally taking into consideration the front wheel speed Vf that is subject to hydroplaning, once hydroplaning occurs, the first vehicle speed Vv1 does not indicates a correct value. However, the first vehicle speed Vv1 is obtained based on a road bump, etc. Therefore, the first vehicle speed Vv1 is subject to hydroplaning, but is not subject to a road bump, etc. Hydroplaning does not usually occur at a rough road with full of rod bumps, etc. According to this preferred embodiment, by utilizing the characteristics of the first and second vehicle speeds Vv1, Vv2, detection of hydroplaning can be made without confusing with a road bump, etc.

Construction of the first vehicle speed measuring means 12 for measuring the first vehicle speed Vv1 will be described with S reference to FIG. 3 and the like.

The digital filter 121 (121f, 121r) is a digital-type band pass filter which processes detection values V (Vf, Vr) of the wheel speed to be inputted one after another and which merely passes a component with a certain frequency. The reason why the digital filter merely permits a certain frequency is to remove variations of the wheel speed due to lack of uniformity of the tire and to extract wheel speed variations derived from a road bump, etc.

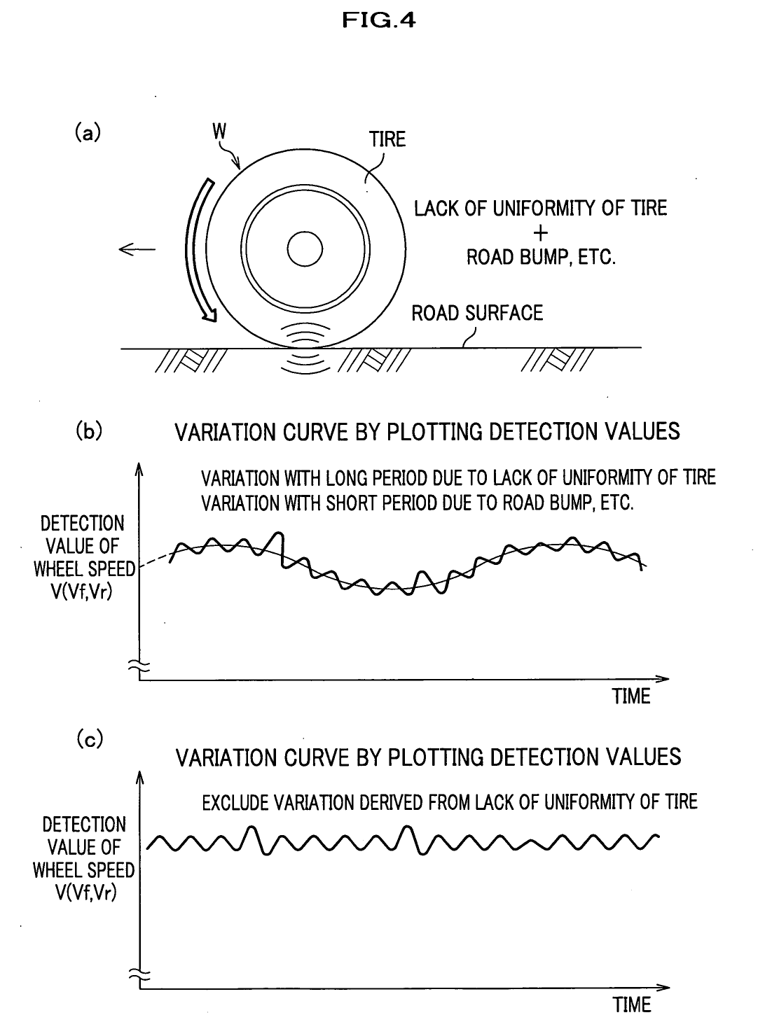

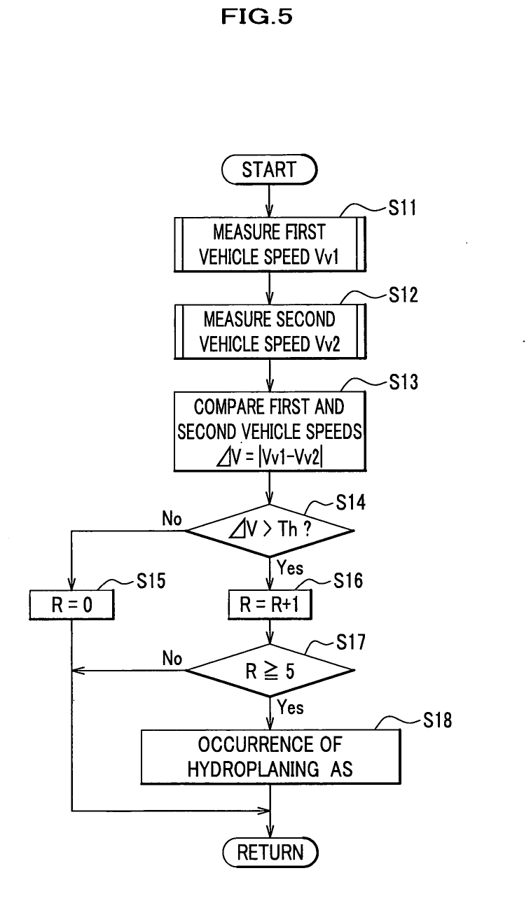

Because tires are produced by winding rubber, steal wires, etc., non-uniformity (lack of uniformity) exists on strength or density during one rotation of the tire. As best seen in FIG. 4(a), when wheels W rotate on the road surface, even if the vehicle C (FIG. 1) runs at a certain speed, a large variation occurs in time variations of detection values V (variation curve of wheel speed detection values) obtained by the wheel speed sensors VS (see FIG. 4(b)) due to lack of uniformity. A variation with a short period that is derived from a road bump, etc. is superposed on this variation with a long period. Because the first vehicle speed measuring means 12 is for calculating an absolute first vehicle speed Vv1 from a wheel speed variation due to a road bump, etc., as shown in FIG. 4(c), the hydroplaning detection apparatus 1 excludes a variation component resulting from the lack of uniformity of the tire by means of the digital filter 121 (i.e., excluding inherent tire influences on the detection values) to smoothly execute subsequent processes. As the wheel speed becomes faster, the period (frequency) of the wheel speed variation derived from the lack of uniformity of the tire and the period (frequency) of the wheel speed variation derived from the road bump, etc. become short as a whole (shift to higher frequency band). Therefore, the digital filter 121 is constructed such that as the wheel speed increases the wheel speed variation at higher frequency band passes through the digital filter 121.

The buffer controller 122 (122f, 122r) functions to receive, at every 10 millisecond, a detection value V (Vf, Vr) of the wheel speed that has passed through the digital filter 121 and to write a predetermined number of detection values in the data buffer 123 (123f, 123r). Further, the buffer controller 122 functions to read out the predetermined number of detection values from the data buffer 123.

The data buffer 123 (123f, 123r) is a read/write memory for temporally storing a predetermined number of detection values V (Vf, Vr). Reading and writing the data can be performed through the buffer controller 122 (122f, 122r). Detection values V (Vf, Vr) are stored in the data buffer 123 in association with process counters n, m, each of which counts the number of processes. To be more specific, detection values Vf for the front wheel side are stored in the data buffer 123f as array variables Vf(n) in association with the process counter n, and detection values Vr for the rear wheel side are stored in the data buffer 123r as array variables Vr(m) in association with the process counter m. The data buffer 123 is a FIFO (First In First Out).

First In First Out operation will be described. The data buffer 122f provided at the front wheel side stores detection values Vf, the number of which is N, as the array variable Vf(n). When a new detection value Vf is stored in the data buffer 123f from the buffer controller 122f, all the array variables Vf(1) to Vf (N) that have been stored currently in the data buffer 123f are read out. After that, the array variable Vf(n) increases its index n by one. As best seen in Table 1 below, the index n increases such that the former array variable Vf(1) becomes Vf(2) and the former array variable Vf(N−1) becomes the array variable Vf (N) so that the detection values Vf over a certain past period of time are in order renewed accordingly. As a result, a new detection value Vf is stored in the array variable Vf(1), and the oldest array variable Vf (N) is erased. Relation between the index n and its final value N is 1≦n≦N (herein, N>1).

TABLE 1
METHOD OF STORING DETECTION VALUES Vf INTO
DATA BUFFER 123f

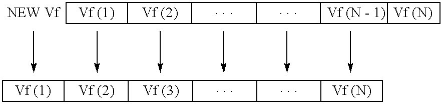

The data buffer 123r at the rear wheel side stores detection values Vr, the number of which is M, as the array variable Vr(m). Because the rear wheel side data buffer 123r operates in the same manner as the front wheel side data buffer 123f, detailed description thereof will be omitted. Relation between the index m and its final value M is 1≦m≦M (herein, M>1).

The predetermined number (final value N, M) is 16 (final value N=16) for the front wheel side buffer controller 122f. Meanwhile, the predetermined number (final value M) is 30 (final value M=30) for the rear wheel side buffer controller 122r. The reason for restricting the number of data to be stored in the data buffers 123f, 123r is to release a load required for the calculation process at the normalization means 124 or at the cross-correlation function calculation means 125 to be described later. Even if the number of data is restricted, absolute first vehicle speed Vv1 can be measured in a reliable manner. Although the initial value of each process counter n, m is 0, the process counter n, m actually counts the number starting from 1. Therefore, the process counter n counts a positive number substantially from 1 to 16, and the process counter m counts a positive number substantially from 1 to 30. The rear wheel side process counter m counts the final value M that is greater than the final value N of the front wheel side process counter n. This is because a change appeared at the front wheel side, such as a change of the detection value V upon passing over a bump, occurs at the rear wheel side with a certain time interval. In order to reliably store and detect the same change appeared at the rear wheel side, a sufficient number is set as the final value M.

In this preferred embodiment, the data buffer 123 receives the detection value V (Vf, Vr) from the digital filter 121 at every 10 millisecond. In this instance, if the detection value Vf is repeatedly stored in the array variable Vf(n) until the process counter n counts the final value of 16, the data buffer 123f stores detection values Vf corresponding to the actual time of 150 milliseconds (150 milliseconds=(16−1)×10 milliseconds). Likewise, if the detection value Vr is repeatedly stored in the array variable Vr (m) until the process counter m counts the final value of 30, the data buffer 123r stores detection values Vr corresponding to the actual time of 290 milliseconds (290 milliseconds=(30−1)×10 milliseconds).

The data buffers 123f, 123r store detection values Vf, Vr at every 10 millisecond, and the array variables Vf(1) through Vf(16) and the array variables Vr(1) through Vr(30) are read out at every 10 millisecond. Therefore, regardless of the size of each data buffer 123f, 123r, the first vehicle speed Vv1 is obtained at every 10 millisecond.

The normalization means 124 (124f, 124r) will be described below.

The front wheel side normalization means 124f functions to read out all the 16 array variables Vf(n) from the data buffer 123f through the buffer controller 122f. Further, in order to facilitate the subsequent process at the cross-correlation function calculation means 125, the front wheel side normalization means 124f functions to execute a normalization process by removing the vehicle speed component from the detection values Vf (=array variable Vf(n)). For this reason, the normalization means 124f processes to calculate the average wheel speed AVf from among the array variables Vf(1) to Vf(16). The average wheel speed AVf at the front wheel side is obtained by the following equation (1).

AVf=ΣVf(n)/16=(Vf(1)+Vf(2)+ . . . +Vf)/16 (1)

The front wheel side normalization means 124f executes a normalization process for the array variables Vf(n) by the following equation (2) and excludes the vehicle speed component (average wheel speed AVf).

Vf(n)=Vf(n)−AVf (2)

Because the process counter n counts a positive number from 1 to 16, the front wheel side normalization means 124f repeatedly calculates the equation (2) 16 times until the process counter n increases the number one by one and then counts the final value (N=16). Accordingly, normalized array variables Vf(1) to Vf(16) can be obtained.

According to this preferred embodiment, the same variable identifier Vf(n) is utilized for variables before and after the normalization process is applied to. This is for saving the number of variable identifiers.

The rear wheel side normalization means 124r also executes a normalization process similar to the front wheel side normalization means 124f. To avoid duplication, description of the rear wheel side normalization means 124r will be omitted. The average wheel speed AVr at the rear wheel side is obtained by the following equation (3).

AVr=ΣVr(m)/30=(Vr(1)+Vr(2)+ . . . +Vr)/30 (3)

The rear wheel side normalization means 124r executes a normalization process by the following equation (4).

Vr(m)=Vr(m)−AVr (4)

Because the process counter m counts a positive number from 1 to 30, the rear wheel side normalization means 124r repeatedly calculates the equation (4) 30 times until the process counter m increases the number one by one and then counts the final value (M=30). Accordingly, normalized array variables Vr(1) to Vr (30) can be obtained.

The cross-correlation function calculation means 125 calculates (executes) cross-correlation functions in a sort of 5 Fourier transformation. Specifically, the cross-correlation function calculation means 125 processes to determine how (at which point) the change pattern derived from the road bump, etc. that is appeared at the front wheel Wf within 150 milliseconds appears at the rear wheel Wr within 290 milliseconds. Therefore, the cross-correlation function calculation means 125 receives the whole array variables Vf(n), Vr(m) that have been normalized by the normalization means 124 (124f, 124r), and executes the convolution shown by the following equations (5) through (19).

Equations (8) to (18) are omitted.

S(1)=Vf(1)·Vr(1)+Vf(2)·Vr(2)+ . . . +Vf·Vr (5)

S(2)=Vf(1)·Vr(2)+Vf(2)·Vr(3)+ . . . +Vf·Vr(17) (6)

S(3)=Vf(1)·Vr(3)+Vf(2)·Vr(4)+ . . . +Vf·Vr(18) (7)

S(15)=Vf(1)·Vr(15)+Vf(2)·Vr(16)+ . . . +Vf·Vr(30) (19)

Herein, S(1) to S(15) are expressed as S(j). S(j) is an array variable in which 15 calculation results (j=1 to 15) of the cross-correlation functions (convolution integration) are stored. Further, “j” indicates an index required to assign the data address.

Once the result data are stored in the array variable S(j) by the result of calculating the cross-correlation functions, the first vehicle speed can be measured without any trouble even if the array variables Vf(n), Vr(m) are read out. For this reason, upon completing calculation of the cross-correlation functions, the cross-correlation function calculation means 125 reports the completion of the process (not shown) to the buffer controller 122 (122f, 122r). When the buffer controller 122 receives the process completion report, the buffer controller 122 reads out the array variables Vf(1) through Vf(16), Vr(1) through Vr(30) which have not stored in the array variable S (j), with the storage of new detection values V (Vf, Vr) into the data buffer 123 determined as a trigger.

The maximum value extraction means 126 calculates a function to extract the maximum value of the array variable S(j). To be more specific, the maximum value extraction means 126 extracts the maximum value from the array variable S(j), into which the results of the above convolution integration are assigned, by the following equation (20).

Ssim=max|S(1), S(2), S(3), . . . , S (20)

The vehicle speed calculation means 127 processes to determine the time difference Δt from the value of the index j, by which the array variable S(j) takes the maximum value, and also processes to calculate the first vehicle speed Vv1 by the following equations (21) and (22), based on the previously stored reference distance, such as the wheel base WB between the front wheel Wf and the rear wheel Wr of the vehicle C.

Δt[sec]=10[mil sec]/1000[mil sec/sec]×(j−1) (21)

Vv1[km/hr]=WB[m]/Δt[sec]×3600[sec/hr]/1000[m/km] (22)

The time difference Δt corresponds to the term “time difference from a coincidence of the change patterns”. The value “10” appeared in the equation (21) indicates the sampling interval for each detection value Vf, Vr. The reason for subtracting 1 from the index j is to obtain the interval number.

Second Vehicle Speed Measuring Means

As seen in FIG. 2, the second vehicle speed measuring means 13 receives detection values Vr of the rear wheel Wr through the input/output interface 11. The second vehicle speed measuring means 13 functions to calculate the moving average as the second vehicle speed Vv2 that is not subject to hydroplaning. For this reason, the second vehicle speed measuring means 13 includes a non-illustrated FIFO (First In First Out) and processes to calculate the moving average from the detection values Vr inputted through the input/output interface 11. As previously described, FIFO is a memory to carry out a first-in first-out operation. FIFO stores detection values Vr, the number of which is K, as the array variable Vr (k). FIFO in order deletes the oldest array variable Vr (K) whenever a new detection value Vr is stored in the FIFO as the array variable Vr (1). This is the same as the previously described FIFO. Relation between the index k and its final value K is given by 1≦k≦K (herein, K>1). The final value K is, for example, 5.

When a new detection value Vr is stored in FIFO, the FIFO reads out all the array variables Vv(1) through Vv(5) at once to calculate the second vehicle speed Vv2 by the following equation (23).

Vv2=ΣVr(k)/K=(Vv(1)+Vv(2)+ . . . +Vv(K))/K (23)

In this preferred embodiment, because the sampling interval of the detection value Vr is 10 milliseconds, the second vehicle speed Vv2 corresponds to the average wheel speed at the rear wheel Wr for 50 milliseconds. The second vehicle speed Vv2 is also measured at every 10 millisecond. The reason for measuring the second vehicle speed Vv2 by means of moving average is to extract the variation of the detection values Vr derived from a road bump, etc. Accordingly, the second vehicle speed Vv2 is not subject to hydroplaning and a road bump, etc.

Vehicle Speed Comparison Means

The vehicle speed comparison means 14 receives the first vehicle speed Vv1 and the second vehicle speed Vv2 from the first vehicle speed measuring means 12 and the second vehicle speed measuring means 13, respectively, and calculates a deviation ΔV(=|Vv1−Vv2|) between the first vehicle speed Vv1 and the second vehicle speed Vv2. As is apparent from the equation in the parentheses, the deviation ΔV is an absolute value of the difference and always takes a positive value.

Threshold Value Storage Means

The threshold value storage means 15 is a memory which stores a threshold value Th that is to be compared with the deviation ΔV at the subsequent determination means 16. The threshold value Th is set based on experimental results, etc. The greater the threshold value Th, the less the detection error for hydroplaning will be. Meanwhile, the smaller the threshold value Th, the earlier the detection for hydroplaning will be made. To warn the driver of hydroplaning at an early stage, it is preferable that the threshold value Th is small.

Determination Means

The determination means 16 receives the deviation ΔV and the threshold value Th respectively from the vehicle speed comparison means 14 and the threshold value storage means 15. The determination means 16 then increases a determination counter R (R=R+1) if the deviation ΔV is greater than the threshold value Th (ΔV>Th), and resets the determination counter R to zero (R=0) if the deviation ΔV is not greater than the threshold value Th (ΔV≦Th) The determination means 16 functions to determine that hydroplaning has occurred if the determination counter R exceeds a certain determinative threshold value. The determination means 16 also functions to produce an alarm signal As and to output it to the alarm AL. In this preferred embodiment, the predetermined determinative threshold value is 5 (FIG. 5). If this determinative threshold value becomes greater, less detection error will occur. Meanwhile, if the determinative threshold value becomes smaller, hydroplaning can be detected at an early stage. To warn the driver of hydroplaning at an early stage, it is preferable that the determinative threshold value is small.

According to this preferred embodiment, the hydroplaning detection apparatus 1 refers to the detection history. This can decrease detection errors of hydroplaning. Further, because detection of hydroplaning is executed at every 10 milliseconds while referring to the detection history, it is possible to inform the driver of detection results of hydroplaning at an early stage in accordance with road conditions that change momentarily.

In this preferred embodiment, the processes carried out by the digital filter 121, the buffer controller 122, the data buffer 123, and the normalization means 124 are corresponding to “excluding inherent tire influences on the detection values” and “feature extracting”. The processes carried out by the cross-correlation function calculation means 125, the maximum value extraction means 126, and the vehicle speed calculation means 127 are corresponding to “pattern matching” and “calculating a first vehicle speed”. Further, the instance “if the determination counter R exceeds the determinative threshold value” is corresponding to the instance “if the deviation exceeds the certain value for a certain period of time”.

Operation of Hydroplaning Detection Apparatus

With reference to FIGS. 1 through 8, operation of the hydroplaning detection apparatus 1 according to this preferred embodiment will be described.

In this preferred embodiment, detection of hydroplaning is carried out in accordance with the flow chart of FIG. 5.

Step S11

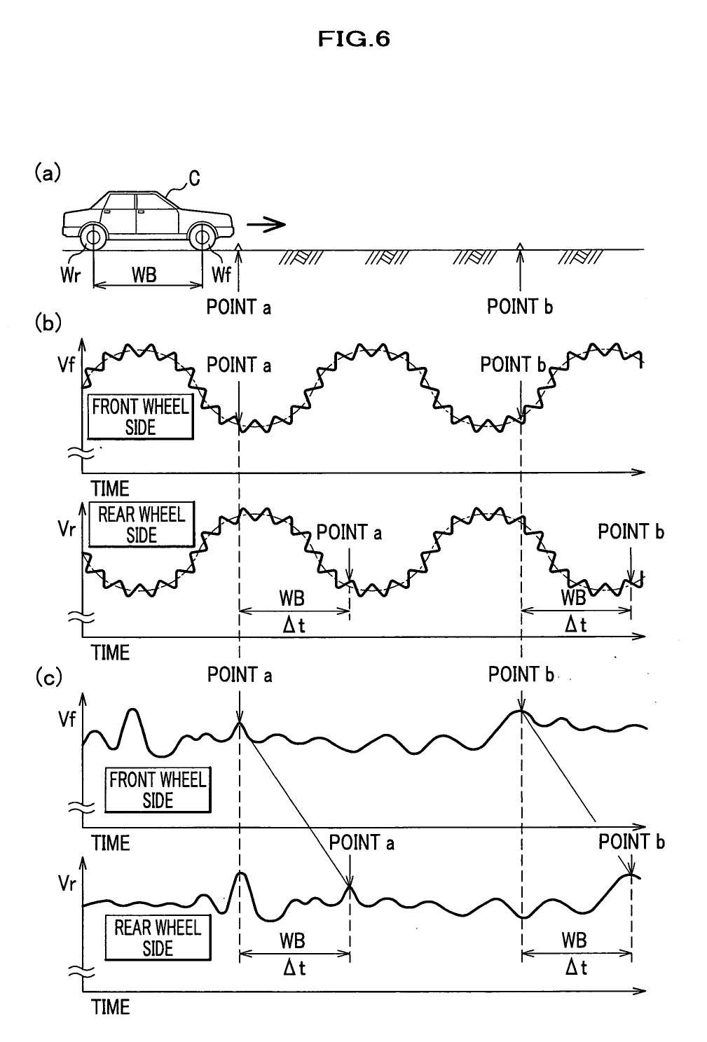

At first, the first vehicle speed measuring means 12 measures (calculates) the first vehicle speed Vv1 that is subject to hydroplaning but is not subject to a road bump, etc. (S11). The measuring operation for the first vehicle speed Vv1 will be described in detail with reference to FIGS. 6 to 8, and appropriately to FIG. 1.

Excluding Variations Derived from Lack of Uniformity of Tire

To measure the first vehicle speed Vv1, it is necessary to exclude a variation of detection values Vf, Vr of the wheel speed derived from lack of uniformity of the tire. As shown in FIG. 6(a), the vehicle C runs at a certain vehicle speed along the road including points a and b. When the vehicle C starts to move, detection values V (Vf, Vr) of the wheel speed are inputted from the wheel speed sensors VS (VSf, VSr) to the hydroplaning detection apparatus 1 through the input/output interface 11. As described above, because of lack of uniformity of each tire at the front and rear wheels Wf, Wr, a variation with a long period due to the lack of uniformity and a variation with a short period due to a road bump, etc. are superposed on the detection values Vf, Vr detected by the wheel speed sensor VS (see FIG. 6(b)). Even if the vehicle C runs at a constant speed, the detection values Vf, Vr vary due to lack of uniformity of the tire and the influence of the road bump, etc. In this preferred embodiment, in order to measure the first vehicle speed Vv1 based on a variation (change) of the detection values Vf, Vr of the wheel speed due to a road bump, etc., the digital filter 121 processes to exclude a variation derived from lack of uniformity of the tire from the detection values Vf, Vr.

As shown in FIG. 6(c), a variation derived from lack of uniformity of the tire can be excluded from the detection values Vf, Vr by the process of the digital filter 121. Therefore, it is possible to reliably measure (calculate) the first vehicle speed Vv1 as an absolute speed. In FIG. 6, the upper figures in (b) and (c) are for the front wheel side (front wheel Wf), and the lower figures in (b) and (c) are for the rear wheel side (rear wheel Wr).

Recording Detection Values in Data Buffer

The detection values Vf, Vr, from which the variation due to lack of uniformity of the tire has been excluded by the digital filter 121, are transmitted to the buffer controller 122 at every 10 milliseconds. Thereafter, the detection values Vf, Vr are stored in the data buffers 123f, 123r as array variables Vf(n) Vr(m).

As a result, 16 detection values Vf are stored in order at every 10 millisecond as the array variables Vf (n), and 30 detection values Vr are stored in order as the array variables Vr(m). Therefore, the preparation for the subsequent process (calculation process for the first vehicle speed Vv1) is completed.

Calculating First Vehicle Speed

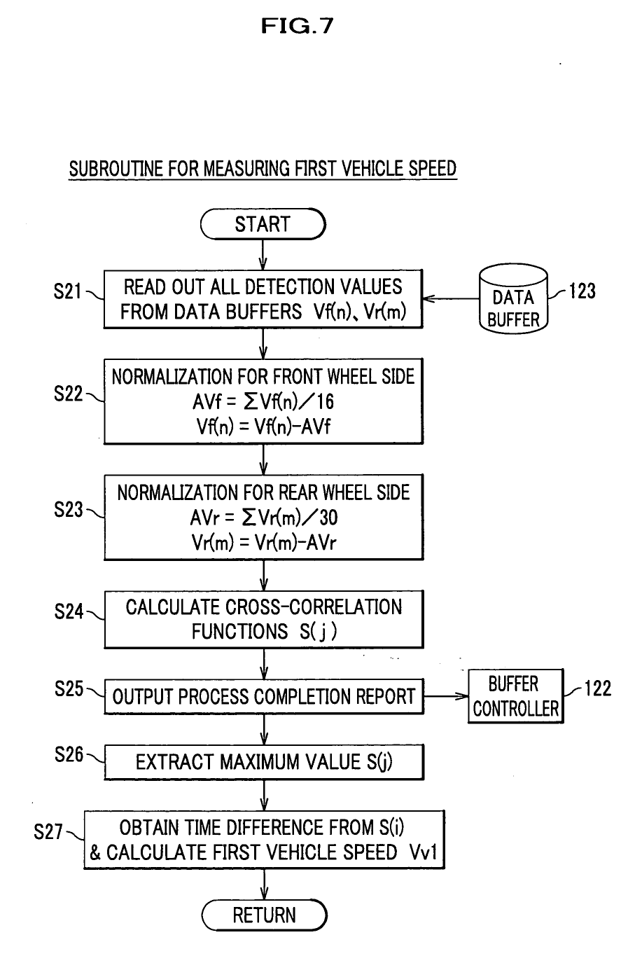

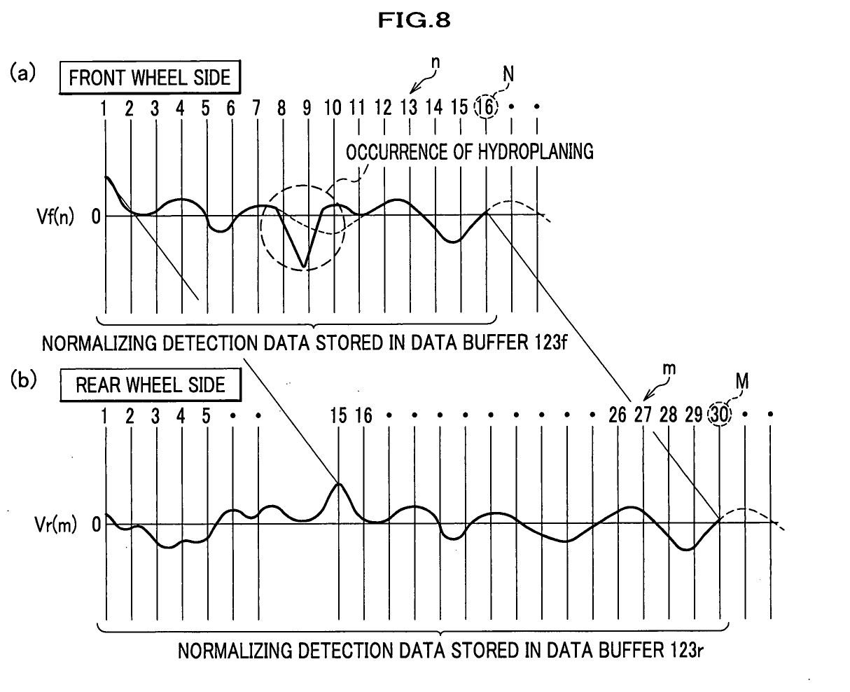

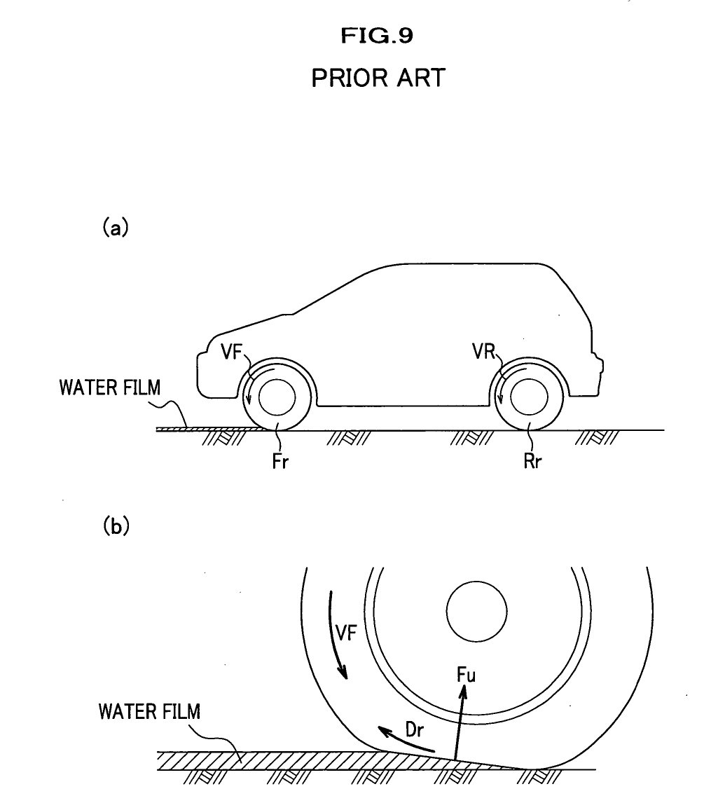

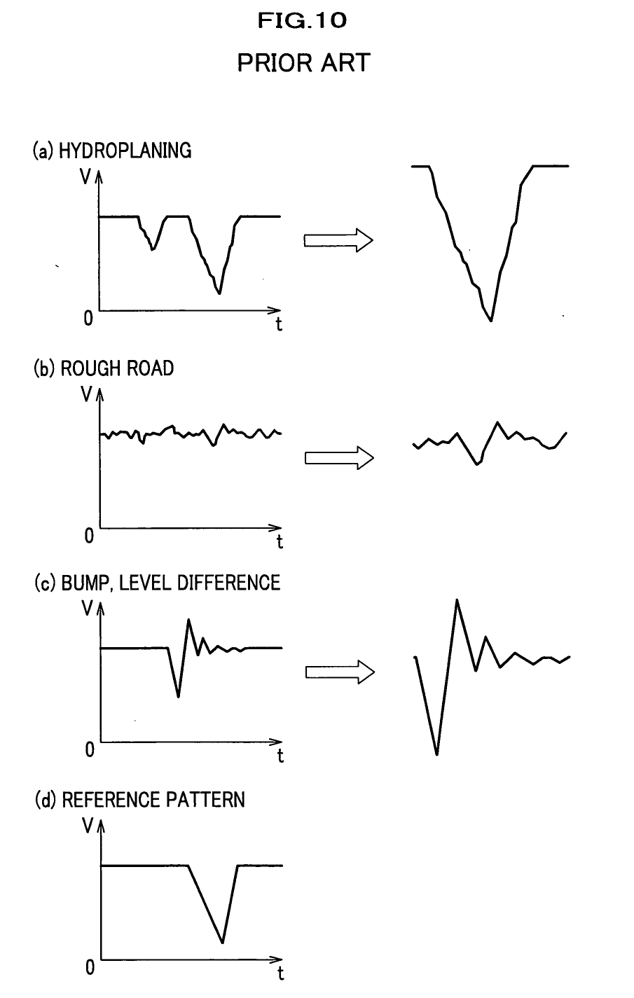

When the certain number of array variables Vf (n), Vr (m) are stored in the data buffers 123f, 123r, as shown in the flow chart of FIG. 7, all the array variables Vf(n), Vr(m) are read out as the detection values from the data buffers (S21). The normalization is then carried out for the front and rear wheel sides according to the previously described processes (S22, S23). During the normalization the equations (1) to (4) are used for calculations. By the result of the normalization, the array variables Vf(n), Vr(m) are schematically shown, for example, by the graphs of FIG. 8. As previously described, in order to save the memory, the same variable identifiers are utilized before and after the normalization.

After the normalization is completed in steps S22, S23, the cross-correlation functions are calculated with the use of the equations (5) to (19) (S24). To avoid repetitions, the equations (5) to (19) are also given by the following equation (24).

S(j)=Vf(1)·Vr(1+j)+Vf(2)·Vr(2+j)+ . . . +Vf·Vr(16+j) (24)

Upon calculating the cross-correlation functions and storing the result data in the array variables S(j) in step S24, the array variables Vf(n), Vr(m) are ready to store new data. The cross-correlation function calculation means 125 then outputs the process completion report to the buffer controller 122 in step S25. Thereby, new detection values Vf, Vr can be stored in the data buffer 123 as the array variables Vf(n), Vr(m).

In step S26, the maximum value is extracted from the array variable S(j) according to the equation (20). Thereafter, the index j of the maximum value S(j) is specified, and the time difference At is determined by way of substituting the index into the equation (21). The thus obtained time difference At and the wheel base WB that is previously stored in the hydroplaning detection apparatus 1 are substituted into the equation (22) to calculate the first vehicle speed Vv1 (S27). Herein, the calculation of the cross-correlation functions in step S24 and the extraction of the maximum value in step S26 are corresponding to a trial (i.e., pattern matching) for overlapping the two graphs (a) and (b) shown in FIGS. 8, and the determination of the time difference Δt in step S27 is corresponding to determining a phase difference between coincidence points of the two graphs.

Determination of the phase difference will be additionally described with reference to FIG. 8 and the equations (5) to (19).

For example, in the equation (5) where the phases are not overlapped in conformity (the patterns are different) at the front and rear wheel sides, the product such as obtained by multiplying Vf(2) by Vr(2) and the product such as obtained by multiplying Vf(3) by Vr(3) take negative values, and the product such as obtained by multiplying Vf(16) by Vr(16) takes a positive value. Accordingly, the sum S (1) of these variables is calculated by adding positive values and negative values.

Also in the equation (6) where the phases are not overlapped in conformity, the sum S (2) of the variables is calculated by adding positive values and negative values (see (a) and (b) of FIG. 8).

However, in the equation (19) where the phases are overlapped in conformity (the patterns are coincident), the product obtained by multiplying Vf(1) by Vr(15) through the product obtained by multiplying Vf(16) by Vr(30) all take positive values. Therefore, the sum S(15) of these variables becomes the maximum value of S(j) where j is from 1 to 15.

For this reason, if the index j by which S (j) takes the maximum value can be found, it is possible to find out the phase difference based on this index j and the sampling interval (10 milliseconds in this preferred embodiment).

Next, the process in step S27 will be described in detail with the use of specific numbers.

If the array variable S (15) takes the maximum value (j=15, S26), the time difference Δt is 140 milliseconds (=(15−1)×10 milliseconds =0.14 seconds). In this instance, if the wheel base WB is 2.83 m, the first vehicle speed Vv1 can be calculated as follows by the equation (22).

$$\begin{matrix}V v1 = W B / Δ t \times 3600 / 1000 \\ = 2.83 / 0.14 \times 3.6 \\ = 73 [ km \text{/} h r ]\end{matrix} \qquad ( 22 )$$

After calculation of the first vehicle speed Vv1, operation proceeds to RETURN for the continued processes. Step S21 through step S27 are thereby repeated in order and the first vehicle speed Vv1 is measured at every 10 millisecond.

FIG. 8(a) shows a change pattern of the wheel speed (detection value Vf) at the front wheel side, wherein in the rounded part shown by the broken line the graph is plotted by the solid line and the broken line. The solid line indicates a change pattern of the detection values Vf in the case where hydroplaning occurs, at which the detection values Vf abruptly decreases. On the contrary, the broken line in the rounded part indicates a change pattern of the detection values Vf in the case where hydroplaning does not occur. This change pattern is very similar to the change pattern of the wheel speed (detection values Vr) at the rear wheel side as shown in (b) of FIG. 8.

If hydroplaning occurs, the value of “j” by which the array variable S (j) takes the maximum value is different from the value “j” in the instance where hydroplaning does not occur (j=15 in the above example). When hydroplaning occurs and the value “j” takes a different value, a false value is obtained as the first vehicle speed Vv1 (i.e., the first vehicle speed Vv1 does not indicate the correct value).

The steps S21 to S23 in the flow chart corresponds to the term “to feature extract” defined in the claims, and the steps S24 and S26 corresponds to the term “to execute pattern matching”.

Steps S12 Through S18

As seen in FIG. 5, in step S12, the second vehicle speed measuring means 13 measures (calculates) the second vehicle speed Vv2 based on the detection values Vr at the rear wheel side. As previously described, the second vehicle speed Vv2 is measured as the moving average of the detection values Vr.

In the next step S13, the vehicle speed comparison means 14 calculates a deviation ΔV between the first vehicle speed Vv1 obtained in step S11 and the second vehicle speed Vv2 obtained in step S12. The determination means 16 then determines whether the deviation ΔV exceeds the threshold value Th in step S14. If the deviation ΔV is not greater than the threshold value Th (No; ΔV≦Th), the determination counter R is reset to zero (R=0) in step S15, and operation proceeds to RETURN so as to repeat the processes from step S11. If the deviation ΔV is greater than the threshold value Th (Yes; ΔV>Th) in step S14, the determination counter R increases its number (R=R+1) in step S16.

After increment of the determination counter R, a determination is made as to whether the determination counter R indicates the determinative threshold value of 5 or more in step S17. If the determination counter R indicates less than 5 (No; R<5), operation proceeds to RETURN so as to repeat the processes from step S11. If the determination counter R indicates the determinative threshold value of 5 or more (Yes; R≧5), more specifically, if the deviation ΔV exceeds the threshold value Th continuously for 5 times or more, the hydroplaning detection apparatus 1 determines that hydroplaning has occurred (detection of a hydroplaning condition), and produces an alarm signal AS (step S18). Accordingly, the alarm AL shown in FIG. 1 operates to warn the driver of hydroplaning.

The above hydroplaning detection apparatus 1 determines a hydroplaning condition based on a deviation ΔV between the first vehicle speed Vv1 that is subject to hydroplaning but is not subject to a road bump, etc. and the second vehicle speed Vv2 that is not subject to hydroplaning and a road bump, etc. This makes it possible to detect hydroplaning in a reliable manner without being affected by a road bump, etc. Namely, detection of hydroplaning can be made by decreasing or eliminating detection errors, which are derived from a change in wheel speed due to a road bump, etc. Therefore, the hydroplaning detection apparatus 1 can reliably detect hydroplaning even if the thickness of the water film is less than 10 mm. The hydroplaning detection apparatus 1 can also detect partial hydroplaning.

In step S14 of FIG. 5, the deviation ΔV becomes greater than the threshold value Th only when hydroplaning occurs. Because hydroplaning does not occur in a rough road with full of road bumps, etc. even if a water film exists on a wet road surface, the deviation ΔV does not become greater than the threshold value Th. The first vehicle speed Vv1 is measured by utilizing a road bump, etc., so that it is substantially suitable for detection on a rough road without being affected by a road bump, etc. Therefore, detection of hydroplaning can be made without confusing with a rough road, etc.

While the present invention has been described in detail with reference to a specific embodiment thereof, it will be apparent to one skilled in the art that various changes and modification may be made without departing from the scope of the claims.

For example, the first vehicle speed Vv1 may be obtained from the moving average. Instead of detecting hydroplaning by the wheel speed sensors VSf, VSr provided at right-side wheels Wf, Wr of the vehicle C, the wheel speed sensors VSf, VSr may be provided at left-side of the vehicle C. Also, the wheel speed sensors may be provided at both sides of the vehicle C so as to detect hydroplaning based on the detection values V from both sides of the vehicle C. Further, the second vehicle speed Vv2 may be the average wheel speed of the rear wheels Wr2, the moving average of the wheel speed of one rear wheel Wr2, or the combination thereof.

Further, the first vehicle speed Vv1 may be measured, for example, by pattern matching between the rear wheel side and the front wheel side, during which are detected a change pattern at the rear wheel side and when the same change pattern appeared previously at the front wheel side. It is also possible to set a threshold value for S (j) that takes the maximum value, so that the first vehicle speed Vv1 is calculated (measured) only when the S (j) becomes greater than a certain value (threshold value).

By means of detection of the straight advance movement of the vehicle C, detection of hydroplaning can be made only when the vehicle runs in the straight advance direction. The detection of the straight advance movement can be performed, for example, by detecting wheel speed difference between the right and left wheels.

The final value N, M of each process counter n, m or the determinative threshold value shows an example value, and it is not necessary to restrict the final value or the determinative threshold value to the specific value. Although the sampling interval for detection values has been described as 10 milliseconds, the sampling interval may be shorter as the vehicle speed increases. The final value of the counter may also vary in accordance with the sampling interval or vehicle speed. Further, instead of excluding a variation due to lack of uniformity of the tire by means of software such as a digital filter, it is possible to exclude the lack of uniformity by means of hardware. Also, instead of employing a band pass filter, other filters such as a low-pass filter or high-pass filter may be employed. Processes of the hydroplaning detection apparatus 1 may be executed by means of hardware.

Further, pattern matching is not limited to a specific example using cross-correlation functions.

Determination (detection) of a hydroplaning condition corresponds to determination (detection) of wet μ on a wet road surface.

What is claimed is:

1. A hydroplaning detection apparatus for a vehicle comprising:
wheel speed sensors for detecting vibrations from a road surface through tires, the wheel speed sensors being provided at front and rear wheel sides, respectively;
an input section through which the wheel speed sensors input their detection values; and
a processing unit for processing the detection values to determine hydroplaning, wherein the processing unit operates:
to feature extract a change pattern of the detection values for the respective front and rear wheel sides by excluding inherent tire influences on the detection values;
to execute pattern matching between the front and rear wheel sides on the basis of the feature extracted change patterns of the detection values;
to obtain a time difference from a coincidence of the change patterns;
to calculate a first vehicle speed based on the time difference and a reference distance that is previously stored in the hydroplaning detection apparatus;
to calculate a second vehicle speed based on an average value of wheel speeds detected by the wheel speed sensor that is provided at the rear wheel side; and
to determine that hydroplaning has occurred if a deviation between the first vehicle speed and the second vehicle speed is greater than a certain value.

2. A hydroplaning detection apparatus according to claim 1, wherein the processing unit determines that hydroplaning has occurred if the deviation exceeds the certain value for a certain period of time.

3. A hydroplaning detection apparatus according to claim 1, wherein the reference distance is a wheel base of the vehicle 4. A hydroplaning detection apparatus according to claim 2, wherein the reference distance is a wheel base of the vehicle.
